(19) United States
(12) Patent Application Publication
(10) Pub. No.: US 2024/0004190 A1
(43) Pub. Date: Jan. 4, 2024

(54) Eye Imaging System

(71) Applicant: Apple Inc., Cupertino, CA (US)

(72) Inventor: Lionel E. Edwin, Hollywood, FL (US)

(73) Assignee: Apple Inc., Cupertino, CA (US)

(21) Appl. No.: 18/339,948

(22) Filed: Jun. 22, 2023

Related U.S. Application Data
(60) Provisional application No. 63/367,475, filed on Jun. 30, 2022.

(51) Int. Cl. G02B 27/00; G02B 27/01

(52) U.S. Cl. CPC G02B 27/0093; G02B 27/017; G02B 2027/0138

(57) ABSTRACT

A waveguide with an input coupler and an output coupler that redirects reflected light to a camera. The waveguide may be integrated in a lens of a wearable device such as a pair of glasses. Light sources emit light beams towards the eye. A portion of the light beams are reflected by the surface of the eye towards the input coupler located in front of the eye. The input coupler may be implemented according to diffractive or reflective technologies, and may be a straight or curved line of narrow width to focus at close distances but of a length long enough to sufficiently image the eye. The input coupler changes the angles of the light beams so that the light beams are relayed using total internal reflection and focused towards an output coupler of the waveguide. The light beams are redirected by the output coupler to the camera.

This application claims benefit of priority to U.S. Provisional Application Ser. No. 63/367,475, entitled “Eye Imaging System,” filed Jun. 30, 2022, and which is hereby incorporated herein by reference in its entirety.

### BACKGROUND

Extended reality (XR) systems such as mixed reality (MR) or augmented reality (AR) systems combine computer generated information (referred to as virtual content) with real world images or a real-world view to augment, or add content to, a user's view of the world. XR systems may thus be utilized to provide an interactive user experience for multiple applications, such as applications that add virtual content to a real-time view of the viewer's environment, interacting with virtual training environments, gaming, remotely controlling drones or other mechanical systems, viewing digital media content, interacting with the Internet, or the like.

### SUMMARY

Various embodiments of methods and apparatus for providing eye tracking in head-mounted devices (HMDs) including but not limited to HMDs used in extended reality (XR) applications are described. HMDs may include wearable devices such as headsets, helmets, goggles, or glasses. An XR system may include an HMD which may include one or more cameras that may be used to capture still images or video frames of the user's environment. The HMD may include lenses positioned in front of the eyes through which the wearer can view the environment. In XR systems, virtual content may be displayed on or projected onto these lenses to make the virtual content visible to the wearer while still being able to view the real environment through the lenses.

In at least some systems, the HMD may include gaze tracking technology. In an example gaze tracking system, one or more infrared (IR) light sources emit IR light towards a user's eye. A portion of the IR light is reflected off the eye and captured by an eye tracking camera. Images captured by the eye tracking camera may be input to a glint and pupil detection process, for example implemented by one or more processors of a controller of the HMD. Results of the process are passed to a gaze estimation process, for example implemented by one or more processors of the controller, to estimate the user's point of gaze. This method of gaze tracking may be referred to as PCCR (Pupil Center Corneal Reflection) tracking.

Conventionally, an eye tracking camera is mounted somewhere on the frame of the HMD and pointed towards the eye to image the eye, or on the outside of the HMD and thus imaging the eye through the HMD's display lens. In both cases, the camera cannot obtain a direct view of the eye, as the form factor prevents the camera from being positioned directly in front of the eye, and thus the camera images the eye at an angle.

A solution is to use a waveguide located in the HMD's display component to relay an image of the eye to a sensor located somewhere on the wearable device's frame. However, conventional display waveguides encode image points in angles, and therefore can image objects at infinity. While this could be used to perform retinal tracking, due to the form factor of at least some wearable devices the display is too close to the eye's cornea for this method to be used to capture images for use in a PCCR gaze tracking process.

Embodiments of methods and apparatus are described that enable the imaging of the cornea/pupil with a waveguide. These embodiments allow mature PCCR algorithms to be used with an opto-mechanical design that more naturally fits in HMD form factors such as wearable glasses.

Embodiments include a waveguide layer in the wearable device's display lens that includes a narrow but long in-coupling (or input coupler) oriented in one direction (vertically, horizontally, or at an angle). The in-coupling may use diffraction or reflection to redirect light rays received from the eye at an angle that causes the rays to be directed by the waveguide to an out-coupling using total internal reflection (TIR) or other reflective treatments. The in-coupling also acts to focus the light rays to the out-coupling. The out-coupling may then use reflection or diffraction to redirect the light rays from the waveguide to the eye tracking camera's lens. The eye tracking camera may be located anywhere on the wearable device's frame, and thus out of the user's field of view through the lens. Using this method, a more direct image of the eye's cornea, iris and pupil can be captured by the camera than in conventional eye tracking systems.

Implementing the input coupler as a narrow “slot” (e.g., ˜1 millimeter in width, 20-30 millimeters in length) allows the input coupler to preserve mapping between object points and propagation angles within the waveguide and thus effectively focus at all distances. The input coupler can be located directly in front of the user's eye. Thus, embodiments may be used to image the surface of the eye which located close to the wearable device's lens. This allows a waveguide to be used to capture in-focus images of the cornea, iris and pupil for use in existing PCCR algorithms.

### BRIEF DESCRIPTION OF THE DRAWINGS

FIG. 1 illustrates a conventional location of an eye tracking camera in a head-mounted device (HMD) such as a pair of glasses.

FIG. 2 broadly illustrates using a waveguide with a narrow input coupler and an output coupler in the lens of a HMD such as a pair of glasses to image a user's eye, according to some embodiments.

FIGS. 3A and 3B illustrate a waveguide with a narrow input coupler and an output coupler that redirects light rays to an eye tracking camera located on or near the frame of an HMD, according to some embodiments.

FIGS. 4A through 4C illustrate example HMDs that include a waveguide with a narrow input coupler and an output coupler that redirects light rays to an eye tracking camera located on or near the frame of the HMD, according to some embodiments.

FIGS. 5A and 5B illustrate alternative configurations of the input coupler and output coupler in a waveguide, according to some embodiments.

FIGS. 6A through 6C illustrate various configurations for the waveguide in a lens of an HMD, according to some embodiments.

FIGS. 7A and 7B graphically illustrate redirection of light rays in a waveguide that redirects light rays to an eye tracking camera, according to some embodiments.

FIG. 8 is a flowchart of a method for redirecting light rays received from an eye to an eye tracking camera using a waveguide as illustrated in FIGS. 2 through 7B, according to some embodiments.

FIG. 9 is a block diagram illustrating an example system that may include components and implement methods for capturing images of the eye for use in gaze tracking in an HMD as illustrated in FIGS. 2 through 8, according to some embodiments.

This specification includes references to “one embodiment” or “an embodiment.” The appearances of the phrases “in one embodiment” or “in an embodiment” do not necessarily refer to the same embodiment. Particular features, structures, or characteristics may be combined in any suitable manner consistent with this disclosure.

“Comprising.” This term is open-ended. As used in the claims, this term does not foreclose additional structure or steps. Consider a claim that recites: “An apparatus comprising one or more processor units . . . .” Such a claim does not foreclose the apparatus from including additional components (e.g., a network interface unit, graphics circuitry, etc.).

“Configured To.” Various units, circuits, or other components may be described or claimed as “configured to” perform a task or tasks. In such contexts, “configured to” is used to connote structure by indicating that the units/circuits/components include structure (e.g., circuitry) that performs those task or tasks during operation. As such, the unit/circuit/component can be said to be configured to perform the task even when the specified unit/circuit/component is not currently operational (e.g., is not on). The units/circuits/components used with the “configured to” language include hardware—for example, circuits, memory storing program instructions executable to implement the operation, etc. Reciting that a unit/circuit/component is “configured to” perform one or more tasks is expressly intended not to invoke 35 U.S.C. § 112, paragraph (f), for that unit/circuit/component. Additionally, “configured to” can include generic structure (e.g., generic circuitry) that is manipulated by software or firmware (e.g., an FPGA or a general-purpose processor executing software) to operate in manner that is capable of performing the task(s) at issue. “Configure to” may also include adapting a manufacturing process (e.g., a semiconductor fabrication facility) to fabricate devices (e.g., integrated circuits) that are adapted to implement or perform one or more tasks.

“First,” “Second,” etc. As used herein, these terms are used as labels for nouns that they precede, and do not imply any type of ordering (e.g., spatial, temporal, logical, etc.). For example, a buffer circuit may be described herein as performing write operations for “first” and “second” values. The terms “first” and “second” do not necessarily imply that the first value must be written before the second value.

“Based On” or “Dependent On.” As used herein, these terms are used to describe one or more factors that affect a determination. These terms do not foreclose additional factors that may affect a determination. That is, a determination may be solely based on those factors or based, at least in part, on those factors. Consider the phrase “determine A based on B.” While in this case, B is a factor that affects the determination of A, such a phrase does not foreclose the determination of A from also being based on C. In other instances, A may be determined based solely on B.

“Or.” When used in the claims, the term “or” is used as an inclusive or and not as an exclusive or. For example, the phrase “at least one of x, y, or z” means any one of x, y, and z, as well as any combination thereof.

### DETAILED DESCRIPTION

Various embodiments of methods and apparatus for providing recording indicators in head-mounted devices (HMDs) including but not limited to HMDs used in extended reality (XR) applications are described. HMDs may include wearable devices such as headsets, helmets, goggles, or glasses. An XR system may include an HMD which may include one or more cameras that may be used to capture still images or video frames of the user's environment. In addition, an HMD may be implemented that does not necessarily provide XR capabilities but that does include one or more cameras that may be used to capture still images or video frames of the user's environment. The HMD may include lenses positioned in front of the eyes through which the wearer can view the environment. In XR systems, virtual content may be displayed on or projected onto these lenses to make the virtual content visible to the wearer while still being able to view the real environment through the lenses.

In at least some systems, the HMD may include gaze tracking technology. In an example gaze tracking system, one or more infrared (IR) light sources emit IR light towards a user's eye. A portion of the IR light is reflected off the eye and captured by an eye tracking camera. Images captured by the eye tracking camera may be input to a glint and pupil detection process, for example implemented by one or more processors of a controller of the HMD. Results of the process are passed to a gaze estimation process, for example implemented by one or more processors of the controller, to estimate the user's point of gaze. This method of gaze tracking may be referred to as PCCR (Pupil Center Corneal Reflection) tracking.

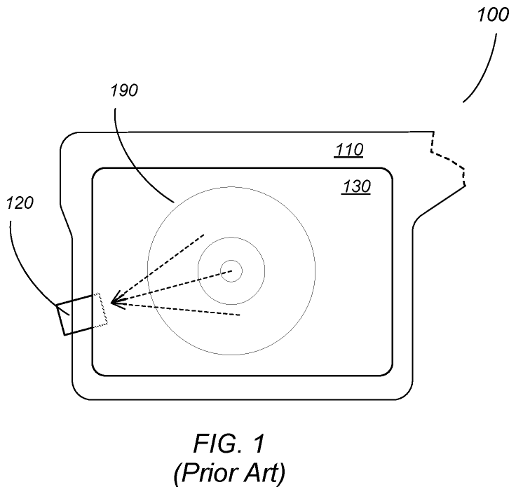

FIG. 1 illustrates a conventional location of an eye tracking camera in a head-mounted device (HMD) 100 such as a pair of glasses. Conventionally, an eye tracking camera 120 is mounted somewhere on the frame 110 of the HMD 100 and pointed towards the eye 190 to image the eye 190, or on the outside of the HMD 100 and thus imaging the eye 190 through the HMD's display lens 130. In both cases, the camera 120 cannot obtain a direct view of the eye 190, as the form factor prevents the camera 120 from being positioned directly in front of the eye 190, and thus the camera 120 images the eye at an angle.

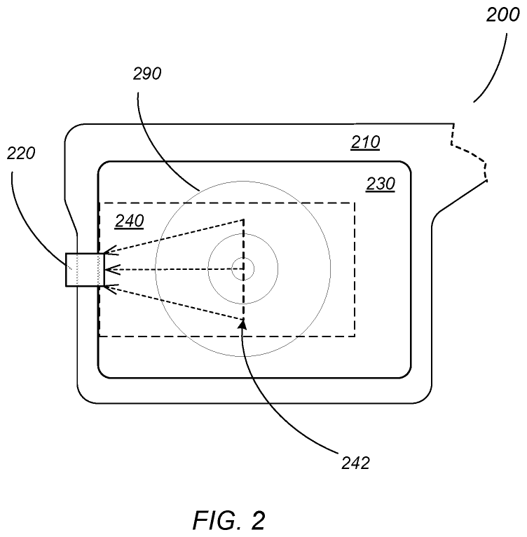

FIG. 2 broadly illustrates using a waveguide with a narrow input coupler and an output coupler in the lens of a HMD such as a pair of glasses to image a user's eye, according to some embodiments. A solution to the problem of directly imaging the eye is to use a waveguide located in the HMD's display component to relay an image of the eye to a sensor located somewhere on the wearable device's frame. However, conventional display waveguides encode image points in angles, and therefore can image objects at infinity. While this could be used to perform retinal tracking, due to the form factor of at least some wearable devices the display is too close to the eye's cornea for this method to be used to capture images for use in a PCCR gaze tracking process.

Embodiments of methods and apparatus are described that enable the imaging of the cornea/pupil of the eye 290 with a waveguide 240 located in the HMD's lens 230. These embodiments allow mature PCCR algorithms to be used with an opto-mechanical design that more naturally fits in HMD form factors such as wearable glasses.

Embodiments are described that include a waveguide layer 240 in the wearable device's lens 230 that includes a narrow but long in-coupling 242 (or input coupler) oriented in one direction (vertically, horizontally, or at an angle). The in-coupling 242 may use diffraction or reflection to redirect light rays received from the eye 290 at an angle that causes the rays to be directed by the waveguide 240 to an out-coupling 244 (or output coupler) using total internal reflection (TIR) or other reflective treatments between the input coupler and output coupler. The in-coupling 242 also acts to focus the light rays to the out-coupling 244. The out-coupling 244 may then use reflection or diffraction to redirect the light rays from the waveguide 240 to the eye tracking camera 220's lens. The eye tracking camera 220's may be located anywhere on the wearable device's frame 210, and thus out of the user's field of view through the lens 230. Using this method, a more direct image of the eye 290's cornea, iris and pupil can be captured by the camera than in conventional eye tracking systems as illustrated in FIG. 1.

Implementing the input coupler 242 as a narrow “slot” (e.g., ˜1 millimeter in width, 20-30 millimeters in length) allows the input coupler to preserve mapping between object points and propagation angles within waveguide and thus effectively focus at all distances. The input coupler 242 can be located directly in front of the user's eye. Thus, embodiments may be used to image the surface of the eye which located close to the wearable device's lens 230. This allows a waveguide 240 to be used to capture in-focus images of the cornea, iris and pupil for use in existing PCCR algorithms.

Embodiments may provide an HMD or wearable device such as a pair of smart glasses that includes an optical stack that enables light (e.g., infrared (IR) light reflected off the user's eye) to be relayed by a waveguide using TIR or other reflective treatments from an input coupler in front of the user's eye to an output coupler located somewhere on the frame of the wearable device. The output coupler redirects the light rays to an eye tracking camera. In embodiments, the optical stack includes passive components including an input coupler, a clear transmissive optical element such as a waveguide, and an output coupler. The input coupler may be implemented using diffractive technologies such as surface relief gratings (SRG) or volume phase holography (VPH), or reflective technologies such as a line of small hot mirrors (for example, parabolic collimated mirrors). In some embodiments, the HMD may also include light sources such as one or more LEDs (light-emitting diodes), or other suitable light emitting devices that emit light (e.g., IR light) towards the user's eye. The one or more light sources may be positioned around the edge of the HMD's frame. Light rays from the light source(s) are reflected off the user's eye, received at the input coupler, and redirected by the input coupler through the waveguide using TIR or other reflective treatments to the output coupler. The input coupler also acts to focus the light rays to the output coupler. The output coupler redirects the light rays to the eye tracking camera. The output coupler may, for example, be implemented as a prism with a reflective surface.

While embodiments are generally described and illustrated with reference to one eye, there may be eye tracking cameras for both eyes, and thus the waveguide technology described herein may be implemented in both the left and right lenses of an HMD.

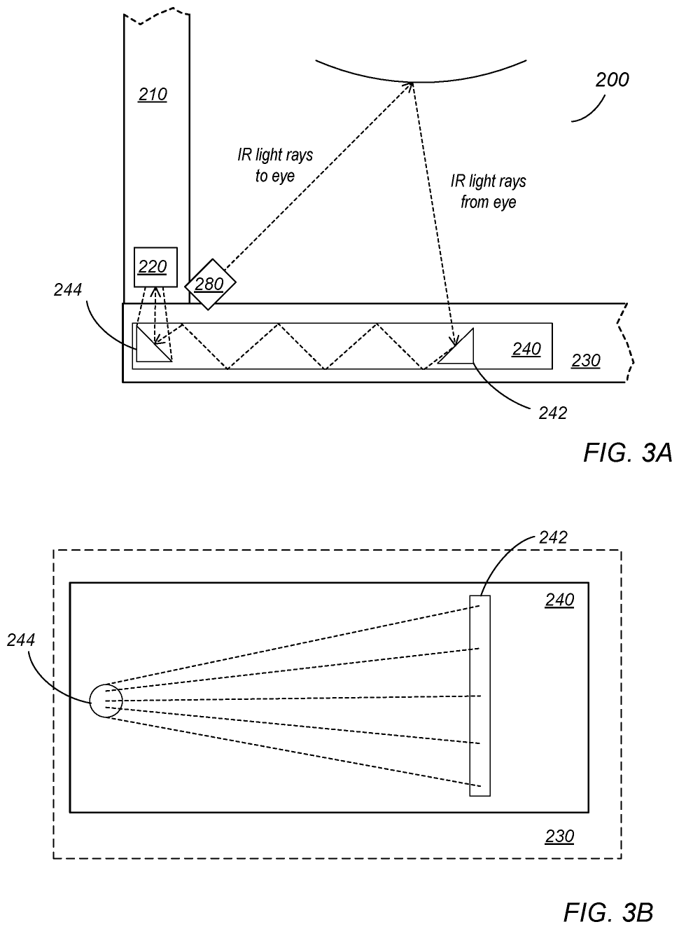

FIGS. 3A and 3B illustrate a waveguide 240 with a narrow input coupler 242 and an output coupler 244 that redirects light rays to an eye tracking camera 220 located on or near the frame 210 of an HMD 200, according to some embodiments. FIG. 3A shows a top (or bottom) view, while FIG. 3B shows a view from the front (or back).

FIG. 3A illustrates that the input coupler 242 uses diffraction or reflection to change the angle of the light rays so that the light rays are redirected by total internal reflection (TIR) within the waveguide 240 towards the output coupler 244. The input coupler 242 may be selected so that it only affects a range within the infrared (IR) portion of the spectrum that is emitted by the light source(s) 280 (e.g., ˜850 or ˜940 nanometers), and thus has little or no effect on light within the visible portion of the spectrum so that a user's view of the environment and of output of display components of the HMID is not negatively affected. The redirected IR light rays are redirected by the output coupler 244 towards an eye tracking camera 220 located somewhere on the HMD's frame 210.

FIG. 3B illustrates that the input coupler 242 also affects the angle of the light rays using diffraction or reflection to focus the light rays at the output coupler 244. The output coupler 244 then focuses the light rays at the aperture of the eye tracking camera 220.

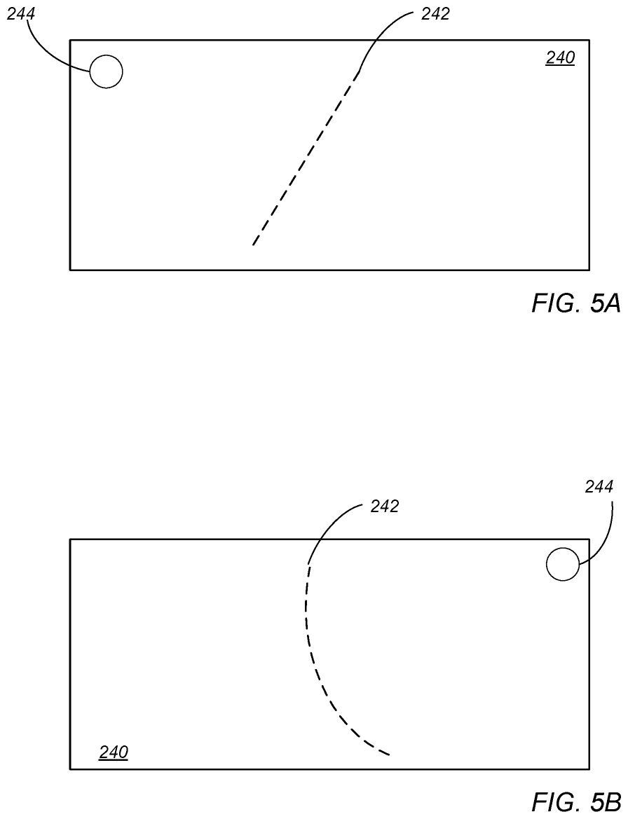

The input coupler 242 may be implemented using diffractive technologies such as surface relief gratings (SRG) or volume phase holography (VPH), or reflective technologies such as a line of small hot mirrors. While the input coupler 242 is shown as a straight vertical line, in some embodiments the input coupler 242 may be at an angle or horizontal, depending on the location of the camera 220 on the frame 210, as shown in FIG. 5A. In addition, in some embodiments the input coupler 242 may be a curved line as shown in FIG. 5B. Depending on the form factor of the wearable device 200, the input coupler 242 may be 20 to 30 millimeters in length, although shorter or longer lengths may be used. A key factor in determining length of the input coupler 242 is the need to provide sufficient coverage of the eye, and thus the length may vary depending on what that coverage needs to be and how far the input coupler 242 is located from the surface of the eye. The width of the input coupler 242 may be around one millimeter, or within a range of 0.5 to 1.5 millimeters, although narrower or wider widths may be used in some embodiments. Key factors in determining an optimal width of the input coupler 242 are the need to collect sufficient light rays to form a usable image at the camera 220, and the need to avoid light rays that are redirected by the input coupler 242 into the TIR angle from bouncing off the surface of the waveguide and reentering the input coupler 242, which may happen on one edge if the input coupler 242 is too wide.

In an example embodiment using reflective technology, the input coupler 242 may be a line of small hot mirrors, for example 500 micron×500 micron mirrors embedded in a substrate (the waveguide) that is ˜750 microns thick. Any of several manufacturing methods may be used. For example, one method may be to diamond turn surfaces on a glass substrate and index match the substrate with another layer. In effect, this creates an embedded glass that includes the micromirrors; the micromirrors can be designed and manufactured to point any direction.

The line of micromirrors may be configured to act as a parabolic collimated mirror. Reflected IR light from the eye comes into the input coupler 242 in parallel rays, the parabolic collimated mirror focuses the light rays to a single point (the output coupler 244). The parabolic collimated mirror performs two functions—redirecting the light rays to an angle to allow TIR within the waveguide as shown in FIG. 3A, and also redirecting the light rays towards the output coupler 244 as shown in FIG. 3B. Thus, each micromirror may be configured with a curvature an/or tilt angle on one axis to redirect the light rays to the TIR angle, and with a curvature and/or tilt angle on the other axis to redirect the light rays towards the output coupler 244.

The output coupler 244 may, for example, be implemented as a prism with a reflective surface. The reflective surface may simply be a flat plane that is angled to “break” total internal reflection and thus redirect the light rays towards the aperture of the camera 220. The diameter of the output coupler 244 may depend on the diameter of the aperture of the camera 220 and distance from the output coupler 244 to the camera 220 aperture. A typical diameter may be around 2 millimeters, although narrower or wider diameters may be used in some embodiments depending on the stated factors.

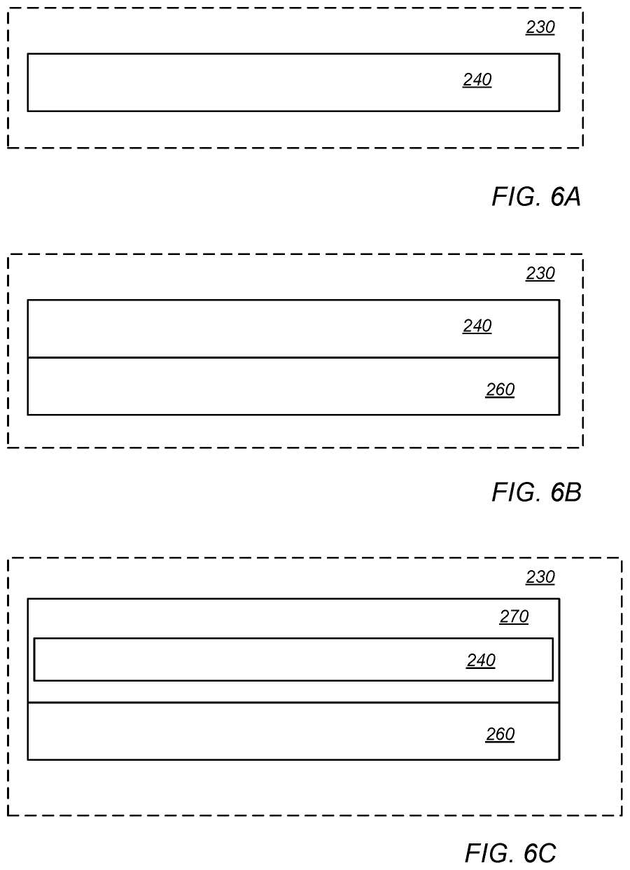

The light source 280 may be an infrared light source (e.g., ˜850 or ˜940 nanometers), and may be an LED or other suitable light source. While only one light source 280 is shown, there may be more than one, for example four with one located at each corner of the frame 210 around the lens 230. Different configurations for the waveguide 240 layer in the HMD lens 230 are illustrated with reference to FIGS. 6A through 6C.

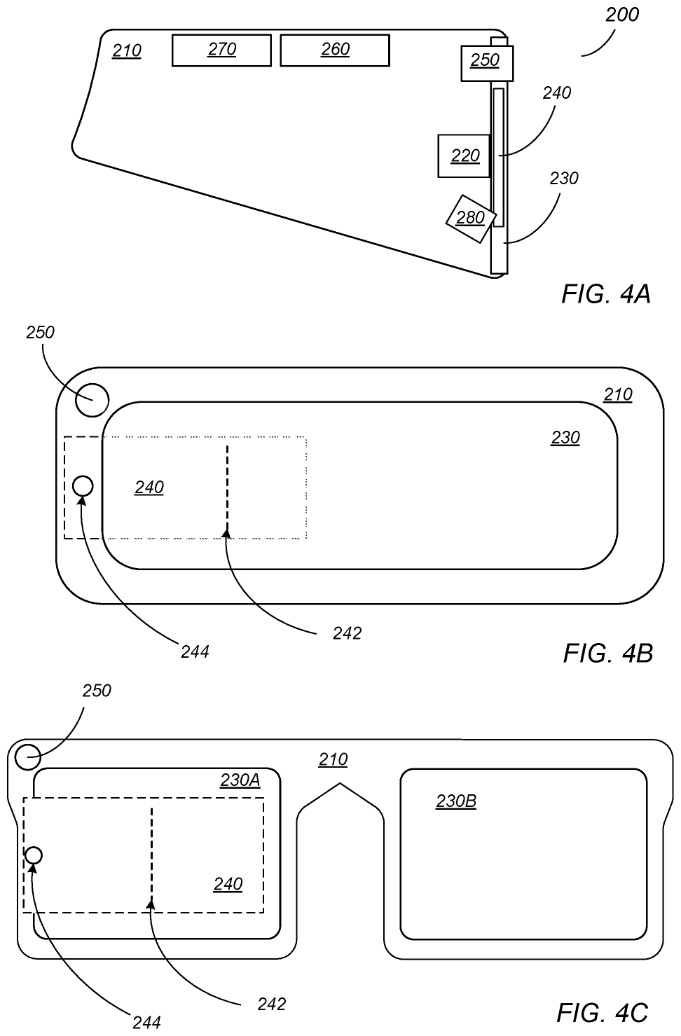

FIGS. 4A through 4C illustrate example HMDs that include a waveguide with a narrow input coupler and an output coupler that redirects light rays to an eye tracking camera located on or near the frame of the HMD, according to some embodiments. Note that the HMDs 200 as illustrated in FIGS. 2A through 2C are given by way of example, and are not intended to be limiting. In various embodiments, the shape, size, and other features of an HMD 200 may differ, and the locations, numbers, types, and other features of the components of an HMD 200 and of the eye imaging system. FIG. 2A shows a side view of an example HMD 200, and FIGS. 2B and 2C show alternative front views of example HMDs 200, with FIG. 2A showing a goggle-like device that has one lens 230 that covers both eyes and FIG. 2B showing a glasses-like device that has right 230A and left 230B lenses.

HMD 200 may include lens(es) 230, mounted in a wearable housing or frame 210. HMD 200 may be worn on a user's head (the “wearer”) so that the lens(es) is disposed in front of the wearer's eyes. In some embodiments, an HMD 200 may implement any of various types of display technologies or display systems. For example, HMD 200 may include a display system that directs light that forms images (virtual content) through one or more layers of waveguides in the lens(es) 220; output couplers of the waveguides (e.g., relief gratings or volume holography) may output the light towards the wearer to form images at or near the wearer's eyes. As another example, HMD 200 may include a direct retinal projector system that directs light towards reflective components of the lens(es); the reflective lens(es) is configured to redirect the light to form images at the wearer's eyes.

In some embodiments, HMD 200 may also include one or more sensors that collect information about the wearer's environment (video, depth information, lighting information, etc.) and about the wearer (e.g., eye or gaze tracking sensors). The sensors may include one or more of, but are not limited to one or more eye tracking cameras 220 (e.g., infrared (IR) cameras) that capture views of the user's eyes, one or more world-facing cameras 250 (e.g., RGB video cameras) that can capture images or video of the real-world environment in a field of view in front of the user, and one or more ambient light sensors that capture lighting information for the environment. Cameras 220 and 250 may be integrated in or attached to the frame 210. HMD 200 may also include one or more light sources 280 such as LED point light sources that emit light (e.g., light in the IR portion of the spectrum) towards the user's eye or eyes.

A controller 260 for the XR system may be implemented in the HMD 200, or alternatively may be implemented at least in part by an external device (e.g., a computing system) that is communicatively coupled to HMD 200 via a wired or wireless interface. Controller 260 may include one or more of various types of processors, image signal processors (ISPs), graphics processing units (GPUs), coder/decoders (codecs), system on a chip (SOC), CPUs, and/or other components for processing and rendering video and/or images. In some embodiments, controller 260 may render frames (each frame including a left and right image) that include virtual content based at least in part on inputs obtained from the sensors and from an eye tracking system, and may provide the frames to the display system.

Memory 270 for the XR system may be implemented in the HMD 200, or alternatively may be implemented at least in part by an external device (e.g., a computing system) that is communicatively coupled to HMD 200 via a wired or wireless interface. The memory 270 may, for example, be used to record video or images captured by the one or more cameras 250 integrated in or attached to frame 210. Memory 270 may include any type of memory, such as dynamic random-access memory (DRAM), synchronous DRAM (SDRAM), double data rate (DDR, DDR2, DDR3, etc.) SDRAM (including mobile versions of the SDRAMs such as mDDR3, etc., or low power versions of the SDRAMs such as LPDDR2, etc.), RAMBUS DRAM (RDRAM), static RAM (SRAM), etc. In some embodiments, one or more memory devices may be coupled onto a circuit board to form memory modules such as single inline memory modules (SIMMs), dual inline memory modules (DIMMs), etc. Alternatively, the devices may be mounted with an integrated circuit implementing system in a chip-on-chip configuration, a package-on-package configuration, or a multi-chip module configuration. In some embodiments DRAM may be used as temporary storage of images or video for processing, but other storage options may be used in an HMD to store processed data, such as Flash or other “hard drive” technologies. This other storage may be separate from the externally coupled storage mentioned below.

The HMD 200 may include a waveguide 240 as described herein that includes an input coupler 242 and output coupler 244, the waveguide 240 configured to redirect infrared light emitted by the light sources 280 and reflected off the surface of the user's eye to an eye tracking camera 220 located on or at the frame 210 and near, at or past the edge of the HMD's lens 230.

While FIGS. 4B and 4C only show a waveguide 240 for one eye, embodiments may include a separate waveguide 240 as described herein for each eye, along with light sources 280 and cameras 220 for each eye, so that gaze tracking can be performed for both eyes. In addition, while FIGS. 4B and 4C show the output coupler 244 and eye tracking camera 220 located at the side of lens 230 and a vertical input coupler 242, the output coupler 244 and eye tracking camera 220 may be located elsewhere, for example at one of the corners (temple or nasal region) of the frame 210, as illustrated in FIGS. 5A and 5B. In those embodiments, the input coupler 242 may be angled as illustrated in FIG. 5A. In addition, in any configuration, the input coupler 242 may be curved as illustrated in FIG. 5B rather than a straight line.

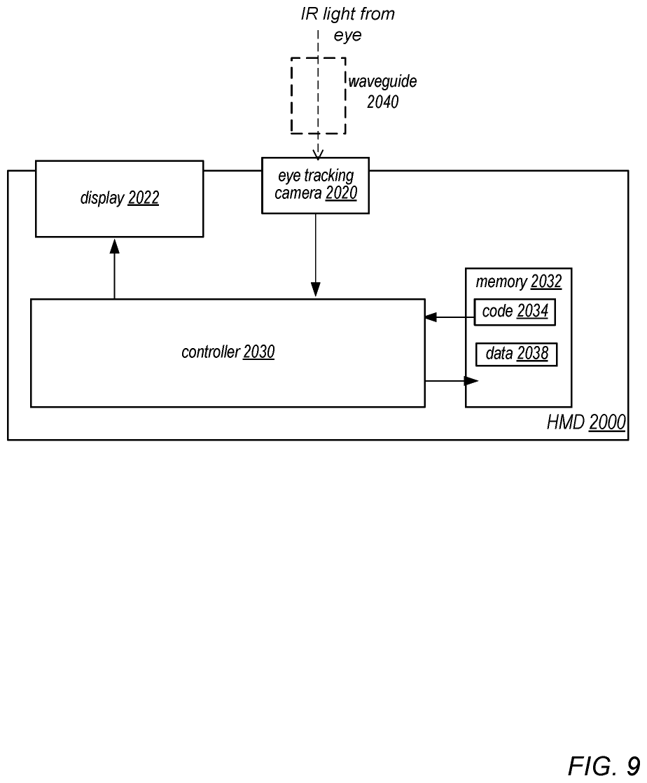

FIG. 9 further illustrates components of an HMD and XR system, according to some embodiments.

Embodiments of an HMD 200 as illustrated in FIGS. 4A-4C may, for example, be used in augmented or mixed (AR) applications to provide augmented or mixed reality views to the wearer. HMD 200 may include one or more sensors, for example located on external surfaces of the HMD 200, that collect information about the wearer's external environment (video, depth information, lighting information, etc.); the sensors may provide the collected information to controller 260 of the XR system. The sensors may include one or more visible light cameras 250 (e.g., RGB video cameras) that capture video of the wearer's environment that, in some embodiments, may be used to provide the wearer with a virtual view of their real environment. In some embodiments, video streams of the real environment captured by the visible light cameras 250 may be processed by the controller 260 of the HMD 200 to render augmented or mixed reality frames that include virtual content overlaid on the view of the real environment, and the rendered frames may be provided to the display system. In some embodiments, input from the eye tracking camera 220 may be used in a PCCR gaze tracking process executed by the controller 260 to track the gaze/pose of the user's eyes for use in rendering the augmented or mixed reality content for display.

FIGS. 5A and 5B illustrate alternative configurations of the input coupler and output coupler in a waveguide, according to some embodiments. As shown in FIG. 5A, the eye tracking camera (not shown) may be located at a corner of the frame, for example near the temple or near the bridge of the nose, and thus the output coupler 244 may be located at a corner of the waveguide 240 and the input coupler 242 may be appropriately angled to redirect light towards the output coupler 244. FIG. 5B shows a similar configuration, but with the input coupler 242 being implemented as a curved rather than a straight line.

FIGS. 6A through 6C illustrate various configurations for the waveguide in a lens of an HMD, according to some embodiments. The waveguide 240 layer may be integrated in the HMD lens 230 in several different ways as illustrated with reference to FIGS. 6A through 6C. The Lens may be composed of a number of layers, for example a cover glass layer, one or more waveguide layers, and a prescription layer. In some embodiments, one layer may be a waveguide used to relay image data from a projection system through an input coupler to an output coupler in front of the user's eye; light output from the output coupler forms an image at an image plane or “eye box” in front of the user's eye. In some embodiments, the eye imaging components (input coupler 242 and output coupler 244) may be integrated in the same waveguide 240 used for display, as shown in FIG. 6A. Alternatively, the eye imaging waveguide 240 may be implemented as a separate layer from the imaging waveguide 260 as shown in FIG. 6B. (Waveguide 240 may be located on either the eye-facing or the world-facing side of waveguide 260). In some embodiments, lens 230 may include a prescription layer 270 configured to provide a particular optical prescription for the user. The prescription layer may be implemented as an optical glass or plastic with one curved side and one flat side, or with two curved sides. In some embodiments, the eye imaging waveguide 240 may be implemented as a substrate within the prescription layer 270 as shown in FIG. 6C.

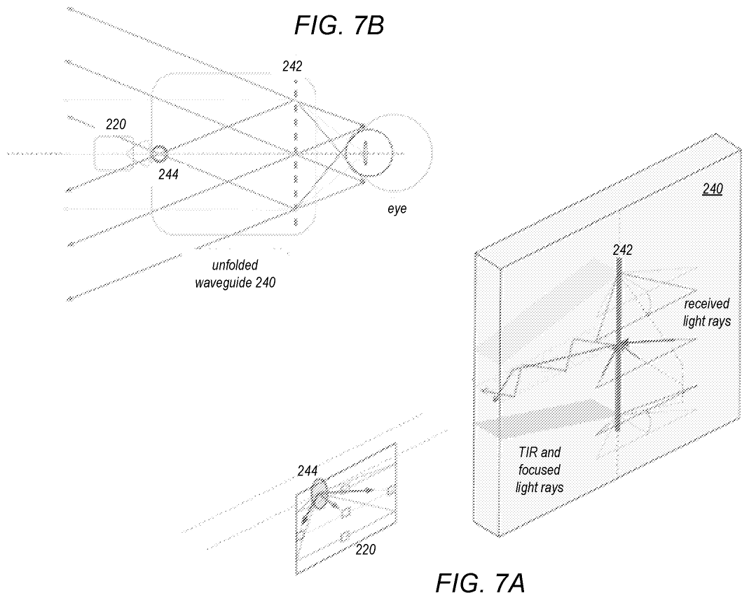

FIGS. 7A and 7B graphically illustrate redirection of light rays in a waveguide 240 that redirects light rays to an eye tracking camera, according to some embodiments. FIG. 7A graphically illustrates how the input coupler 242 redirects received light rays to an angle so that TIR is performed in the waveguide and the light rays are focused towards the output coupler 244. FIG. 7A also shows how the output coupler 244 breaks the TIR to redirect the light rays to the eye tracking camera 220 to form an image on the image sensor of the camera 220. FIG. 7B graphically illustrates the same process in a different (unfolded view) manner.

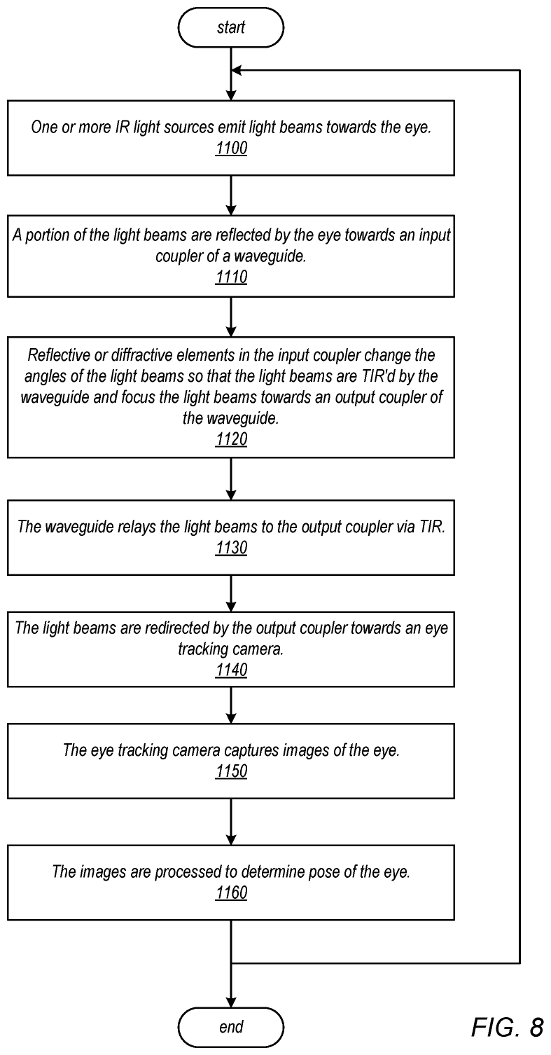

FIG. 8 is a flowchart of a method for redirecting light rays received from an eye to an eye tracking camera using a waveguide as illustrated in FIGS. 2 through 7B, according to some embodiments. As indicated at 1100, one or more IR light sources (e.g., LED light sources) emit light beams towards the eye. As indicated at 1110, a portion of the light beams are reflected by the surface of the eye towards an input coupler of a waveguide; the input coupler may be located directly in front of the eye. The input coupler may be implemented according to diffractive or reflective technologies as described herein, and may be a straight or curved line of narrow width but of a length long enough to sufficiently image the eye. As indicated at 1120, one or more reflective or diffractive elements in the input coupler changes the angles of the light beams so that the light beams are at an angle to be directed by the waveguide using total internal reflection (TIR) or other reflective treatments and focused towards an output coupler of the waveguide. As indicated at 1130, the waveguide relays the focused light beams to the output coupler, for example using TIR. As indicated at 1140, the light beams are redirected by the output coupler towards an eye tracking camera. As indicated at 1150, the eye tracking camera captures images of the eye. As indicated at 1160, the images may be processed by a controller of the HMD, for example to determine gaze direction and/or pose of the eye. As indicated by the arrow returning from 1160 to 1100, the method may be a continuous process as long as the user is wearing the device.

FIG. 9 is a block diagram illustrating an example system that may include components and implement methods for capturing images of the eye for use in gaze tracking in an HMD as illustrated in FIGS. 2 through 8, according to some embodiments.

In some embodiments, an XR system may include an HMD 2000 such as a headset, helmet, goggles, or glasses. HMD 2000 may implement any of various types of display technologies. For example, HMD 2000 may include a transparent or translucent display 2022 (e.g., eyeglass lenses) through which the user may view the real environment and a medium integrated with display 2022 through which light representative of virtual images is directed to the wearer's eyes to provide an augmented view of reality to the wearer.

In some embodiments, HMD 2000 may include a controller 2030 configured to implement functionality of the XR system and to generate frames (each frame including a left and right image) that are provided to display 2022. In some embodiments, HMD 2000 may also include memory 2032 configured to store software (code 2034) of the XR system that is executable by the controller 2030, as well as data 2038 that may be used by the XR system when executing on the controller 2030. In some embodiments, memory 2032 may also be used to store video captured by camera 2050. In some embodiments, HMD 2000 may also include one or more interfaces (e.g., a Bluetooth technology interface, USB interface, etc.) configured to communicate with an external device (not shown) via a wired or wireless connection. In some embodiments, at least a part of the functionality described for the controller 2030 may be implemented by the external device. The external device may be or may include any type of computing system or computing device, such as a desktop computer, notebook or laptop computer, pad or tablet device, smartphone, hand-held computing device, game controller, game system, and so on.

In various embodiments, controller 2030 may be a uniprocessor system including one processor, or a multiprocessor system including several processors (e.g., two, four, eight, or another suitable number). Controller 2030 may include central processing units (CPUs) configured to implement any suitable instruction set architecture, and may be configured to execute instructions defined in that instruction set architecture. For example, in various embodiments controller 2030 may include general-purpose or embedded processors implementing any of a variety of instruction set architectures (ISAs), such as the x86, PowerPC, SPARC, RISC, or MIPS ISAs, or any other suitable ISA. In multiprocessor systems, each of the processors may commonly, but not necessarily, implement the same ISA. Controller 2030 may employ any microarchitecture, including scalar, superscalar, pipelined, superpipelined, out of order, in order, speculative, non-speculative, etc., or combinations thereof. Controller 2030 may include circuitry to implement microcoding techniques. Controller 2030 may include one or more processing cores each configured to execute instructions. Controller 2030 may include one or more levels of caches, which may employ any size and any configuration (set associative, direct mapped, etc.). In some embodiments, controller 2030 may include at least one graphics processing unit (GPU), which may include any suitable graphics processing circuitry. Generally, a GPU may be configured to render objects to be displayed into a frame buffer (e.g., one that includes pixel data for an entire frame). A GPU may include one or more graphics processors that may execute graphics software to perform a part or all of the graphics operation, or hardware acceleration of certain graphics operations. In some embodiments, controller 2030 may include one or more other components for processing and rendering video and/or images, for example image signal processors (ISPs), coder/decoders (codecs), etc.

Memory 2032 may include any type of memory, such as dynamic random access memory (DRAM), synchronous DRAM (SDRAM), double data rate (DDR, DDR2, DDR3, etc.) SDRAM (including mobile versions of the SDRAMs such as mDDR3, etc., or low power versions of the SDRAMs such as LPDDR2, etc.), RAMBUS DRAM (RDRAM), static RAM (SRAM), etc. In some embodiments, one or more memory devices may be coupled onto a circuit board to form memory modules such as single inline memory modules (SIMMs), dual inline memory modules (DIMMs), etc. Alternatively, the devices may be mounted with an integrated circuit implementing system in a chip-on-chip configuration, a package-on-package configuration, or a multi-chip module configuration. In some embodiments DRAM may be used as temporary storage of images or video for processing, but other storage options may be used to store processed data, such as Flash or other “hard drive” technologies.

In some embodiments, the HMD 2000 may include one or more sensors (not shown) that collect information about the user's environment (video, depth information, lighting information, etc.). The sensors may provide the information to the controller 2030 of the XR system. In some embodiments, the sensors may include, but are not limited to, at least one visible light camera (e.g., an RGB video camera), ambient light sensors, and at least on eye tracking camera 2020. IR light reflected off the eye may be redirected to the eye tracking camera 2020 using a waveguide 2040 as described in reference to FIGS. 2 through 8.

In some embodiments, the HMD 2000 may be configured to render and display frames to provide an augmented or mixed reality (MR) view for the user based at least in part according to sensor inputs, including input from the eye tracking camera 2020. The MR view may include renderings of the user's environment, including renderings of real objects in the user's environment, based on video captured by one or more video cameras that capture high-quality, high-resolution video of the user's environment for display. The MR view may also include virtual content (e.g., virtual objects, virtual tags for real objects, avatars of the user, etc.) generated by the XR system and composited with the displayed view of the user's real environment.

### Extended Reality

A real environment refers to an environment that a person can perceive (e.g., see, hear, feel) without use of a device. For example, an office environment may include furniture such as desks, chairs, and filing cabinets; structural items such as doors, windows, and walls; and objects such as electronic devices, books, and writing instruments. A person in a real environment can perceive the various aspects of the environment, and may be able to interact with objects in the environment.

An extended reality (XR) environment, on the other hand, is partially or entirely simulated using an electronic device. In an XR environment, for example, a user may see or hear computer generated content that partially or wholly replaces the user's perception of the real environment. Additionally, a user can interact with an XR environment. For example, the user's movements can be tracked and virtual objects in the XR environment can change in response to the user's movements. As a further example, a device presenting an XR environment to a user may determine that a user is moving their hand toward the virtual position of a virtual object, and may move the virtual object in response. Additionally, a user's head position and/or eye gaze can be tracked and virtual objects can move to stay in the user's line of sight.

Examples of XR include augmented reality (AR), virtual reality (VR) and mixed reality (MR). XR can be considered along a spectrum of realities, where VR, on one end, completely immerses the user, replacing the real environment with virtual content, and on the other end, the user experiences the real environment unaided by a device. In between are AR and MR, which mix virtual content with the real environment.

VR generally refers to a type of XR that completely immerses a user and replaces the user's real environment. For example, VR can be presented to a user using a head mounted device (HMD), which can include a near-eye display to present a virtual visual environment to the user and headphones to present a virtual audible environment. In a VR environment, the movement of the user can be tracked and cause the user's view of the environment to change. For example, a user wearing a HMD can walk in the real environment and the user will appear to be walking through the virtual environment they are experiencing. Additionally, the user may be represented by an avatar in the virtual environment, and the user's movements can be tracked by the HMD using various sensors to animate the user's avatar.

AR and MR refer to a type of XR that includes some mixture of the real environment and virtual content. For example, a user may hold a tablet that includes a camera that captures images of the user's real environment. The tablet may have a display that displays the images of the real environment mixed with images of virtual objects. AR or MR can also be presented to a user through an HMD. An HMD can have an opaque display, or can use a see-through display, which allows the user to see the real environment through the display, while displaying virtual content overlaid on the real environment.

The following clauses describe various examples embodiments consistent with the description provided herein.

Clause 1. A device, comprising:
a frame;
a camera coupled to the frame;
a lens coupled to the frame and configured to be positioned in front of an eye; and
a waveguide embedded in the lens, wherein the waveguide includes an output coupler and an input coupler, wherein the input coupler is configured to redirect light rays reflected off the eye to the output coupler through the waveguide, and wherein the output coupler is configured to redirect the light rays from the waveguide to the camera;
wherein width of the input coupler is narrower than length of the input coupler.
   Clause 2. The device as recited in clause 1, wherein, to redirect light rays reflected off the eye to the output coupler through the waveguide, the input coupler changes the angles of the light beams so that the light beams are at an angle to be directed by the waveguide using total internal reflection (TIR) and are focused towards the output coupler of the waveguide.
   Clause 3. The device as recited in clause 1, wherein the output coupler is implemented as a prism with a reflective surface that acts to redirect the light rays from the waveguide to the camera.
   Clause 4. The device as recited in clause 1, wherein the input coupler uses diffraction to redirected the light rays.
   Clause 5. The device as recited in clause 4, wherein the input coupler is implemented according to surface relief grating (SRG) technology or according to volume phase holography (VPH) technology.
   Clause 6. The device as recited in clause 1, wherein the input coupler uses reflection to redirect the light rays.
   Clause 7. The device as recited in clause 6, wherein the input coupler is implemented as a line of small hot mirrors, each mirror equal to or less than 1 millimeter×1 millimeter embedded in the waveguide substrate.
   Clause 8. The device as recited in clause 1, further includes one or more light sources configured to emit light rays towards the eye, wherein the emitted light rays are reflected off of the eye towards the input coupler.
   Clause 9. The device as recited in clause 8, wherein the one or more light sources are infrared light sources, and wherein the camera is an infrared camera.
   Clause 10. The device as recited in clause 9, wherein the camera is an eye tracking camera configured to capture images of the cornea, iris, and pupil of the eye as illuminated by the one or more infrared light sources, wherein the captured images are processed by a controller comprising one or more processors to determine gaze direction of the eye.
   Clause 11. The device as recited in clause 1, wherein the input coupler is 20 to 30 millimeters in length and 0.5 to 1.5 millimeters in width.
   Clause 12. The device as recited in clause 1, wherein length of the input coupler is determined to provide sufficient coverage of the eye given distance of the input coupler from the surface of the eye.
   Clause 13. The device as recited in clause 1, wherein an optimal width of the input coupler is determined according to constraints including an amount of light rays required to form a usable image at the camera and a need to prevent light rays that are redirected by the input coupler from bouncing off a surface of the waveguide and reentering the input coupler.
   Clause 14. The device as recited in clause 1, wherein the input coupler is implemented in a straight or in a curved configuration.
   Clause 15. The device as recited in clause 1, wherein the input coupler is vertically oriented or oriented at an angle relative to the lens.
   Clause 16. The device as recited in clause 1, wherein the camera is located at a corner of the frame.
   Clause 17. The device as recited in clause 15, wherein the corner is near a temple or near a bridge of a nose.
   Clause 18. The device as recited in clause 1, wherein the waveguide is a layer in the lens that is also used for displaying virtual images to the user.
   Clause 19. The device as recited in clause 1, wherein the waveguide is implemented as a layer in the lens that is separate from a layer used for displaying virtual image to the user.
   Clause 20. The device as recited in clause 1, wherein the lens includes a prescription layer, wherein the waveguide is embedded in the prescription layer.
   Clause 21. The device as recited in clause 1, wherein the device is a head-mounted device (HMD) of an extended reality (XR) system.
   Clause 22. A system, comprising:
a head-mounted device (HMD), comprising:
a frame;
a controller comprising one or more processors;
a camera integrated in or attached to the frame;
a lens coupled to the frame configured to display virtual content generated by the controller;
one or more infrared light sources configured to emit infrared light rays towards an eye, and
a waveguide embedded in the lens, wherein the waveguide includes an output coupler and an input coupler, wherein the input coupler is configured to use diffraction or reflection to redirect infrared light rays reflected off the eye to the output coupler through the waveguide, and wherein the output coupler is configured to redirect the infrared light rays from the waveguide to the camera, wherein width of the input coupler is narrower than length of the input coupler.
   Clause 23. The system as recited in clause 22, wherein, to redirect light rays reflected off the eye to the output coupler using total internal reflection (TIR), the input coupler changes the angles of the light beams so that the light beams are at an angle to be directed by the waveguide using total internal reflection (TIR) and are focused towards the output coupler of the waveguide.
   Clause 24. The system as recited in clause 22, wherein the output coupler is implemented as a prism with a reflective surface that acts to redirect the light rays from the waveguide to the camera.
   Clause 25. The system as recited in clause 22, wherein the input coupler is implemented according to surface relief grating (SRG) technology or according to volume phase holography (VPH) technology.
   Clause 26. The system as recited in clause 22, wherein the input coupler is implemented as a line of small hot mirrors, each mirror equal to or less than 1 millimeter×1 millimeter embedded in the waveguide substrate.
   Clause 27. The system as recited in clause 22, wherein the camera is an eye tracking camera configured to capture images of the cornea, iris, and pupil of the eye as illuminated by the one or more infrared light sources, wherein the captured images are processed by the controller to determine gaze direction of the eye.

The methods described herein may be implemented in software, hardware, or a combination thereof, in different embodiments. In addition, the order of the blocks of the methods may be changed, and various elements may be added, reordered, combined, omitted, modified, etc. Various modifications and changes may be made as would be obvious to a person skilled in the art having the benefit of this disclosure. The various embodiments described herein are meant to be illustrative and not limiting. Many variations, modifications, additions, and improvements are possible. Accordingly, plural instances may be provided for components described herein as a single instance. Boundaries between various components, operations and data stores are somewhat arbitrary, and particular operations are illustrated in the context of specific illustrative configurations. Other allocations of functionality are envisioned and may fall within the scope of claims that follow. Finally, structures and functionality presented as discrete components in the example configurations may be implemented as a combined structure or component. These and other variations, modifications, additions, and improvements may fall within the scope of embodiments as defined in the claims that follow.

What is claimed is:

1. A device, comprising:
a frame;
a camera coupled to the frame;
a lens coupled to the frame and configured to be positioned in front of an eye; and
a waveguide embedded in the lens, wherein the waveguide includes an output coupler and an input coupler, wherein the input coupler is configured to redirect light rays reflected off the eye to the output coupler through the waveguide, and wherein the output coupler is configured to redirect the light rays from the waveguide to the camera;
wherein width of the input coupler is narrower than length of the input coupler.

2. The device as recited in claim 1, wherein, to redirect light rays reflected off the eye to the output coupler through the waveguide, the input coupler changes the angles of the light beams so that the light beams are at an angle to be directed by the waveguide using total internal reflection (TIR) and are focused towards the output coupler of the waveguide.

3. The device as recited in claim 1, wherein the output coupler is implemented as a prism with a reflective surface that acts to redirect the light rays from the waveguide to the camera.

4. The device as recited in claim 1, wherein the input coupler uses diffraction to redirected the light rays.

5. The device as recited in claim 4, wherein the input coupler is implemented according to surface relief grating (SRG) technology or according to volume phase holography (VPH) technology.

6. The device as recited in claim 1, wherein the input coupler uses reflection to redirect the light rays.

7. The device as recited in claim 6, wherein the input coupler is implemented as a line of small hot mirrors, each mirror equal to or less than 1 millimeter×1 millimeter embedded in the waveguide substrate.

8. The device as recited in claim 1, further comprising one or more light sources configured to emit light rays towards the eye, wherein the emitted light rays are reflected off of the eye towards the input coupler.

9. The device as recited in claim 8, wherein the one or more light sources are infrared light sources, and wherein the camera is an infrared camera.

10. The device as recited in claim 9, wherein the camera is an eye tracking camera configured to capture images of the cornea, iris, and pupil of the eye as illuminated by the one or more infrared light sources, wherein the captured images are processed by a controller comprising one or more processors to determine gaze direction of the eye.

11. The device as recited in claim 1, wherein the input coupler is 20 to 30 millimeters in length and 0.5 to 1.5 millimeters in width.

12. The device as recited in claim 1, wherein length of the input coupler is determined to provide sufficient coverage of the eye given distance of the input coupler from the surface of the eye.

13. The device as recited in claim 1, wherein width of the input coupler is determined according to constraints including a constraint for an amount of light rays required to form a usable image at the camera and a constraint to prevent light rays that are redirected by the input coupler from bouncing off a surface of the waveguide and reentering the input coupler.

14. The device as recited in claim 1, wherein the input coupler is vertically oriented or oriented at an angle relative to the lens.

15. The device as recited in claim 1, wherein the camera is located at a corner of the frame configured to be proximate a temple or a bridge of a nose of a user.

16. The device as recited in claim 1, wherein the waveguide is a layer in the lens that is also used for displaying virtual images to a user.

17. The device as recited in claim 1, wherein the waveguide is implemented as a layer in the lens that is separate from a layer used for displaying virtual image to a user.

18. The device as recited in claim 1, wherein the lens includes a prescription layer, wherein the waveguide is embedded in the prescription layer.

19. The device as recited in claim 1, wherein the device is a head-mounted device (HMD) of an extended reality (XR) system.

20. A system, comprising:
a head-mounted device (HMD), comprising:
a frame;
a controller comprising one or more processors;
a camera integrated in or attached to the frame;
a lens coupled to the frame configured to display virtual content generated by the controller;
one or more infrared light sources configured to emit infrared light rays towards an eye, and
a waveguide embedded in the lens, wherein the waveguide includes an output coupler and an input coupler, wherein the input coupler is configured to use diffraction or reflection to redirect infrared light rays reflected off the eye to the output coupler through the waveguide, and wherein the output coupler is configured to redirect the infrared light rays from the waveguide to the camera, wherein width of the input coupler is narrower than length of the input coupler.
